(19) United States
(12) Patent Application Publication
(10) Pub. No.: US 2001/0025478 A1
(43) Pub. Date: Oct. 4, 2001

(54) Hot air power system with heated multi process expansion

(76) Inventor: Solomon S. Fineblum, Stoughton, MA (US)

Correspondence Address: Solomon S. Fineblum, 33 A Christopher Dr., STOUGHTON, MA, 02072, US

(21) Appl. No.: 09/804,955

(22) Filed: Mar. 13, 2001

Related U.S. Application Data
(60) Provisional application No. 60/189,237, filed on Mar. 14, 2000.

(51) Int. Cl. F02G 1/00; F02G 3/00; F02C 5/00; F01K 7/34

(52) U.S. Cl. 60/39.6; 60/653

(57) ABSTRACT

The external combustion hot air power system comprises a compressor, a recuperator, a heated mult-process expander, a surrounding combustion chamber and necessary fuel system, controls, fluid flow passages, mechanical connections and structure. The multiprocess expander provides for isobaric and isothermal expansions. Air is compressed and then heated by combustion products in a recuperator heat exchanger. This hot compressed air is further heated and expanded at approximately constant pressure in the isobaric expander to generate power. Additional power is generated downstream by isothermal expansion. Hot expanded air flows from the expander into the surrounding combustion chamber to support combustion. Isobaric expansion must be heated by the hottest portion of the combustion chamber to increase the temperature of the expanding gas. Combustion products flow from the combustion chamber and through the hot side of the (recuperator) heat exchanger to regeneratively heat previously compressed air.

### THIS PATENT APPLICATION REFERENCES DISCLOSURE DOCUMENT #458950 STAMPED JUL. 8, 1999 AND PROVISIONAL PATENT APPLICATION 60/189,237.

### FIELD OF INVENTION

A hot air, external combustion power system and engine, in general, and an external combustion power system and engine with a multiprocess expansion and expander exhaust preheated combustion, in particular.

### PRIOR ART

Presently, most combustion engines are internal combustion engines which are noisy, pollute the atmosphere and relatively inefficient. Presently proposed and available external combustion systems based on Stirling and Ericsson cycles are slow, bulky and relatively expensive for the power produced. Typically, external combustion engines have only one heat transfer surface for the transfer of thermal energy into the working fluid. In addition many have reciprocal motion for compression, heating and expansion which results in slow, mechanically complex devices with constant inerruptions. R. Hendriks (U.S. Pat No. 4,922,709 60-39.183 and 60-683) teaches the use of expanded air from one turbine of two or three to support combustion. However, there is no heating of turbine by combustion gasses during expansion as we teach. Further, the air that enters the combustion chamber has been expanded adiabatically and, therefore, already cooled by adiabatic expansion. We, in contrast, transfer into the combustion chamber the hot air that is heated during isothermal expansion. D. G Wilson et al. in “COAL BURNING EXHAUST-HEATED-CYCLE GAS TURBINE WITH A REGENERATIVE HEAT EXCHANGER ”, ASME Paper 91-GT describes an external combustion power system with the hot air turbine exhaust being fed into the combustion chamber. The air within the expander expands adiabatically and enters the combustion chamber after being cooled by such adiabatic expansion. By contrast, our expander is heated and the turbine exhaust, as a result, is much hotter. Importantly, Wilson et al. teach only one heat exchanger for transporting the heat of combustion into the working gas while the present invention incorporates two paths of heat transfer into the working fluid. Similarly, G. Crosa, et al in ASME Paper“STEADY STATE AND DYNAMIC PERFORMANCE OF AN INDIRECT(LY) FIRED GAS TURBINE PLANT” ASME #98-GT -167 also teach an external combustion power system with exhaust heated combustion. However, with adiabatic expansion, turbine exhaust and the combustion chamber inlet air are relatively cool. There is only one heat exchanger into working fluid. S. Fineblum in an ASME paper, “PRELIMINARY ANALYSIS OF AN IMPROVED EXTERNAL COMBUSTION HOT AIR POWER SYSTEM”.ASME Paper # ES -382 from Proceedings of the 39th Intersosciety Energy Conversion Conference, ASME, August 1995,Vol 2 pp 153.-.160, teaches a modified Erricson cycle with an exhaust heated external combustion system with isothermal expansion. That system, however, lacks multiprocess expansion taught here. S. Fineblum in an ASME paper, “PRELIMINARY THEMODYNAMICS OF A PRACTICAL HOT AIR POWER SYSTEM WITH ISOTHERMAL CONBUSTION AND EXPANSION” Proceedings—ASME International Mechanical Engineering Conference, November 1999, Nashville, Tenn., Advanced Energy Systems Division, AES Vol 39, pp 513-521 lacks heated multiprocess expansion taught here.

Peter Holton (U.S. Pat No. 6,012,280) teaches an external combustion power system that operates on a Brayton cycle without the advantages of multiprocess expansion. David Johnson (U.S. Pat No. 4,653,269) teaches an external combustion power system with preheating of combustion air by heat exchange with adiabatically cooled turbine exhaust. Combustion gasses enter expander interior. The present inventor, on the other hand, teaches peheating combustion air in a relatively hot isothermal expander which is never subjected to attack by combustion products.

A. Tort-Oropeza (U.S. Pat No. 5,964,087) teaches that hot pressurized gasses generated in the combustion chamber are expanded in unheated expanders. There is no preheating of the combustion air nor heated expansion. This is essentially a complicated engine for the Brayton Cycle in contrast to our modified Ericsson Cycle.

### OBJECTS AND ADVANTAGES

a. To provide an isothermal external combustion engine that is less polluting, quieter and more efficient than internal combustion engines.,

b. To provide for efficient recovery of energy of hot combustion gasses in external power system by providing two paths for heat transfer into the working fluid.

c. To provide heated expansion which is more efficient than an adiabatic expansion.

d. To provide for heated multiprocess expansion which is more efficient than an isothermal expansion alone.

e. To provide for pre-heated combustion air for more efficient combustion.

f. To provide cooler air flow past highly stressed first stages of the expander.

g. To provide for smooth, uninterrupted processes.

h. To eliminate combustion products from interior of power generating expanders.

### SUMMARY OF INVENTION

The external combustion hot air engine and system comprises a compressor, a recuperator, a heated mult-process expander, which may be comprised of a series of individual expanders, an immediately adjacent combustion chamber and the necessary fuel system, controls, fluid flow passages and mechanical connections between components as well as structure as required.

The multiprocess expander will provide for isobaric, or approximately isobaric, expansion, an intermediate polytropic expansion as well as isothermal expansion, and, in some embodiments, isentropic expansion. The constant, n in the polytropic process of an ideal gas, pV^{u}=constant, where p is the pressure and V is the volume of a closed system, will vary through the expander or serially connected expanders from approximately zero for isobaric expansion to approximately 1 for isothermal expansion and may, in some embodiments increase further. The polytropic process constant of 0, 1 and k indicate isobaric, isothermal and isentropic processes, respectively. The power system operates as a modified Ericsson cycle Air is compressed in a compressor, then flows into the cool side of a recuperator heat exchanger wherein it is heated by thermal contact with the flowing combustion products. This hot compressed air is then further heated and expanded at constant pressure or approximately constant pressure within the isobaric heated expander or the isobaric portion of the heated expander to generate power. Additional power is generated downstream by a sequential isothermal expansion which generates additional power. There will be an intermediate expansion after the completion of the isobaric expansion and prior to isothermal expansion. The hot expanded air flows from the multiprocess expander into an immediately adjacent combustion chamber to efficiently support combustion. The combustion chamber surrounds the various stages of the expander. The combustion gasses are in counter flow to the expanders such that isobaric expansion which occurs in the upstream portion of the expander (or in the upstream expander) is heated by the downstream portion of the combustion chamber. The downstream portion of the combustion chamber is hotter than the upstream portion in order to provide the greater heat flux to increase the temperature of the expanding gas as required for isobaric expansion. The upstream portion of the combustion chamber which surrounds the downstream isothermal portion of the expander may be somewhat cooler because isothermal expansion requires less heat flux than isobaric expansion. After providing heat to the directly adjacent heated expander or expanders the combustion products flow out from the combustion chamber and into and through the hot side of the (recuperator) heat exchanger to regeneratively provide heat to previously compressed air. During normal operation, the heated multiprocess expander drives the compressor as well as generating the output power.

The highest temperature in the entire system ; which is in the combustion chamber surrounding the expanders, is not contact with any any moving parts. This is in contrast with conventional gas turbines where the maximum combustion temperature impinges upon the first stage turbine blades which suffer thermal stress in addition to the mechanical stress due to the combination of centrifugal and shear forces. Other embodiments of this invention will also benefit from the moving parts not being exposed to the hottest gasses in the system. The combustion chamber, as in other external combustion power systems, can be designed to burn a variety of fluid and solid fuels.

### DESCRIPTION OF DRAWINGS

FIG. 1 is a schematic of an external combustion power system with multiprocess expansion.

FIG. 2 is a schematic of another embodiment of an external combustion power with separate multiprocess expanders.

FIG. 3. shows TS and PV diagrams of the external combustion power with multiprocess expansion.

FIG. 4 shows a gas turbine embodiment of an external combustion engine with multiprocess expansion.

FIG. 5 shows details of a multiprocess hot air turbine with hollow stator blades.

FIG. 6 shows details of a multiprocess hot air turbine expander with heat-pipe stator-fins.

FIG. 7 shows a slide vane embodiment of an external combustion engine with multiprocess expansion.

FIG. 8 shows a centripetal turbine embodiment of an external combustion engine with multiprocess expansion.

FIG. 9 shows a simplified flow diagram of an external combustion multiprocess power generation process.

### DESCRIPTION OF PREFERRED EMBODIMENTS

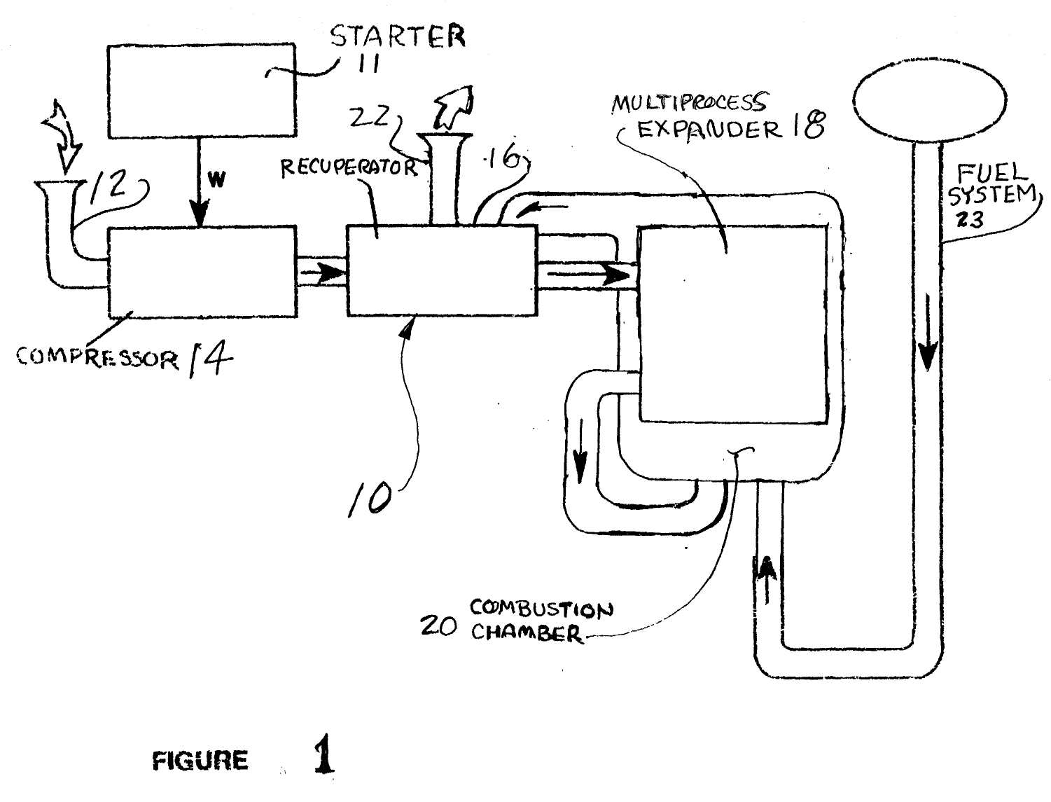

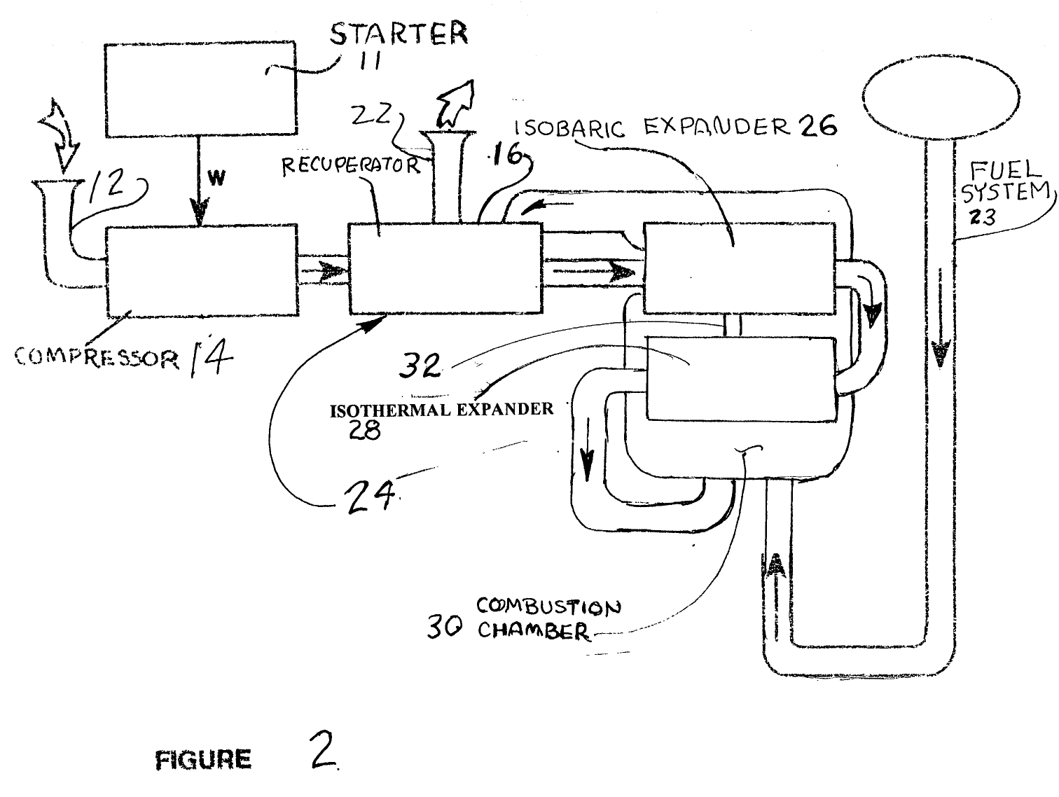

FIG. 1 is a schematic of an external combustion power system 10 with multiprocess expansion. The system includes a starter 11, an air inlet 12, a compressor 14, a regenerative heat exchanger (recuperator) 16, a heated multiprocess expander 18, a combustion chamber 20 surrounding and in immediate contact with heated multiprocess expander 18. An outlet duct 22 exhausts gas from regenerative heat exchanger 16. System 10 also includes control means as well as a fuel system and other auxiliaries as required by conventional gas turbine engines. The system is also provided with sufficient ducting to direct the gasses from component to component as required. Air compressed in compressor 14 flows into the cool side of regenerative heat exchanger 16 wherein it is heated by the flowing combustion products in the hot side of regenerative heat exchanger 16. This hot compressed air is expanded at constant pressure( isobarically) or approximately constant pressure and then at constant temperature within heated multiprocess expander 18 to generate power. Hot expanded air flows from heated multiprocess expander 18 into immediately adjacent combustion chamber 20 to efficiently support combustion there. Combustion chamber 20 surrounds heated expander 18. After providing heat to the directly adjacent heated expander 18, combustion products flow out of combustion chamber 20 and into and through the hot side of the regenerative heat exchanger 16 to regeneratively provide heat to previously compressed air. The cooled combustion products then exit power system 10 through exhaust duct 22. During normal operation, heated expander 18 drives compressor 14 as well as generating output. As a result, heat of combustion is transferred into the hot air through two rather than one heat transfer paths and the hot air is expanded iin both isobarically or approximately isobarically and then isothermally and thus more efficiently. Combustion chamber 20 as in other external combustion power systems can be designed to burn a variety of fluid and solid fuels.

FIG. 2 presents another embodiment of an external combustion power system with multiprocess expansion with isobaric expansion within isobaric expander 26 and isothermal expansion in a separate isothermal expander 28.

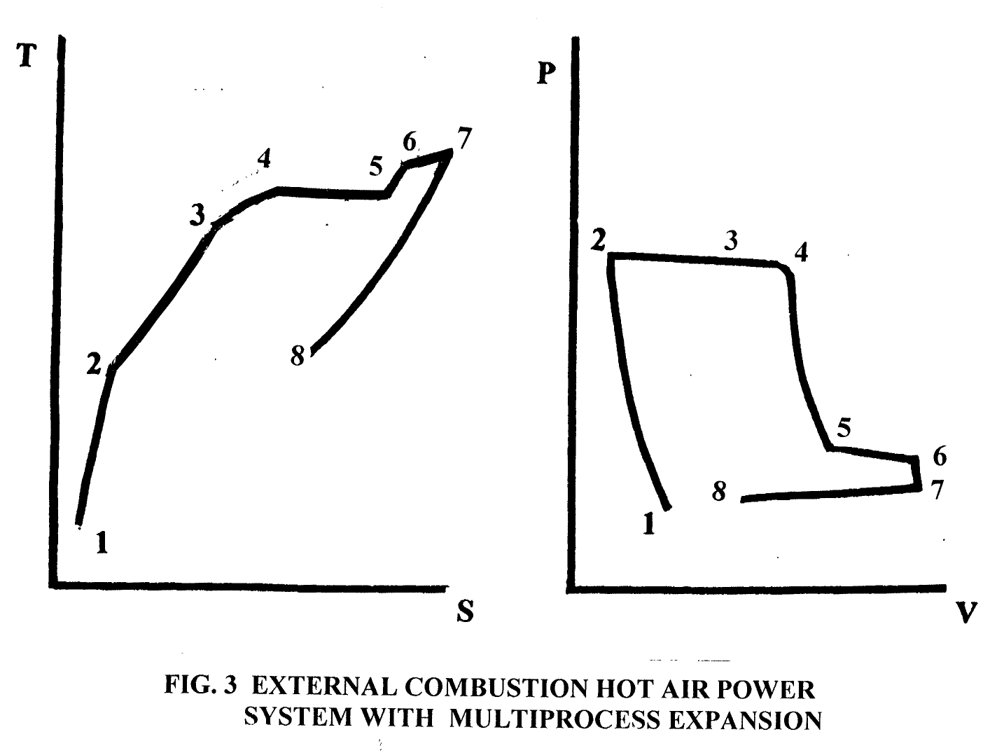

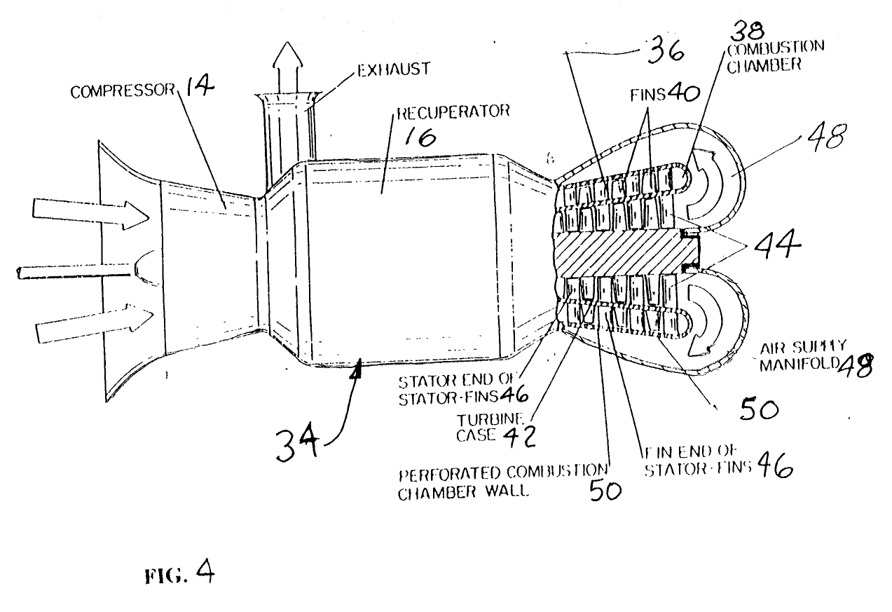

FIG. 3 presents the TS and PV diagrams. Air is compressed 1-2, heated in the regenerative heat exchanger (recuperator) 2-3, and the hot, high pressure air is isobarically heated in the upstream portion of the heated multiprocess expander 3-4 Then the hot high pressure air is expanded isothermally 4 to 5 after which it flows into adjacent combustion chamber and heated 5 to 6. Combustion continues, 6-7 as temperature is increased to a maximum near the combustion chamber outlet to provide heat io adjacent multiprocess expander. The upstream isobaric expansion process requires more heat flux because isobaric expansion requires a temperature increase. This required increased heat flux is provided by the higher combustion temperature in the portion of the combustion chamber which is adjacent to upstream, isobaric, portion of the multiprocess expander. Hot combustion gas then flows through hot side of hot side of recuperator heat exchanger to cool 7 to 8 while preheating compressed air 2 to 3.

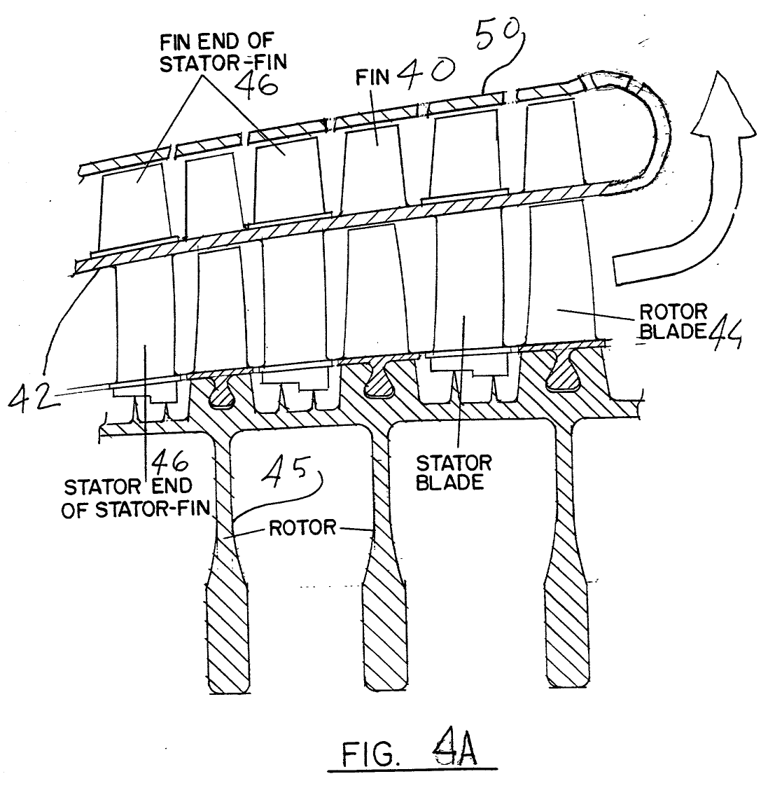

FIG. 4 shows an integrated combustion chamber-hot air turbine 34. Fuel supply, fuel injection and ignition means are not shown. Air compressed in compressor 14 flows into the cool side of regenerative heat exchanger 16 wherein it is heated by thermal contact with flowing combustion products in the hot side of regenerative heat exchanger 16. This hot compressed air is expanded at constant pressure and then at constant temperature within heated multiprocess turbine expander 36 to generate power. Heat transfer between combustion chamber 38 into multiprocess turbine expander 36 is enhanced by fins 40 within combustion chamber 38 which are mounted on the outer surface of the turbine case 42. Stator blades 44 are fixed to turbine case 42. Some of the fin and stator blades are structurally integrated to form stator-fins 46 to further stimulate heat transfer into the interior of multiprocess turbine expander 36. Expanded air from multiprocess turbine expander 36 flows into immediately adjacent combustion chamber 38 by way of air supply manifold 48 to efficiently support combustion there. A perforated combustion chamber wall 50 between air supply manifold 48 and combustion chamber 38 permits a relatively uniform air supply. Combustion chamber 38 is formed to surround multi-process turbine expanders. After providing heat to the directly adjacent heated turbine expander 36, combustion products flow out from combustion chamber 38 and into and through the hot side of the regenerative heat exchanger( recuperator) 16 to regeneratively provide heat to previously compressed air. The cooled combustion products then exit power system 34 through exhaust duct 22. During normal operation, heated multiprocess turbine expander 36 drives compressor 14 as well as generating output. The heated air expands isobarically and then isothermally and thus more efficiently. In addition, the highest temperature in the entire system does not contact any moving parts. This is in contrast to conventional gas turbines where the maximum combustion temperature impinges upon the first stage turbine blades which suffer thermal stress in addition to the mechanical stress due to the combination of centrifugal and shear forces.

FIG. 4A shows a simplified cross-section of portion of an integrated combustion chamber-hot air turbine 34. Heat transfer between the combustion chamber 38 into multiprocess turbine expander 36 is enhanced by fins 40 within combustion chamber 38 which are mounted on the outer surface of the turbine case 42. Stator-blades 44 are fixed to turbine case 42. Some of the fin and stator blades are structurally integrated to form stator-fins 46 to further stimulate heat transfer into the interior of multiprocess turbine expander 36. Rotor blades 44 which are attached to rotor 45, also act as heat transfer augmentation fins. Hot air is supplied from air supply manifold, not shown, through perforated combustion chamber wall 50.

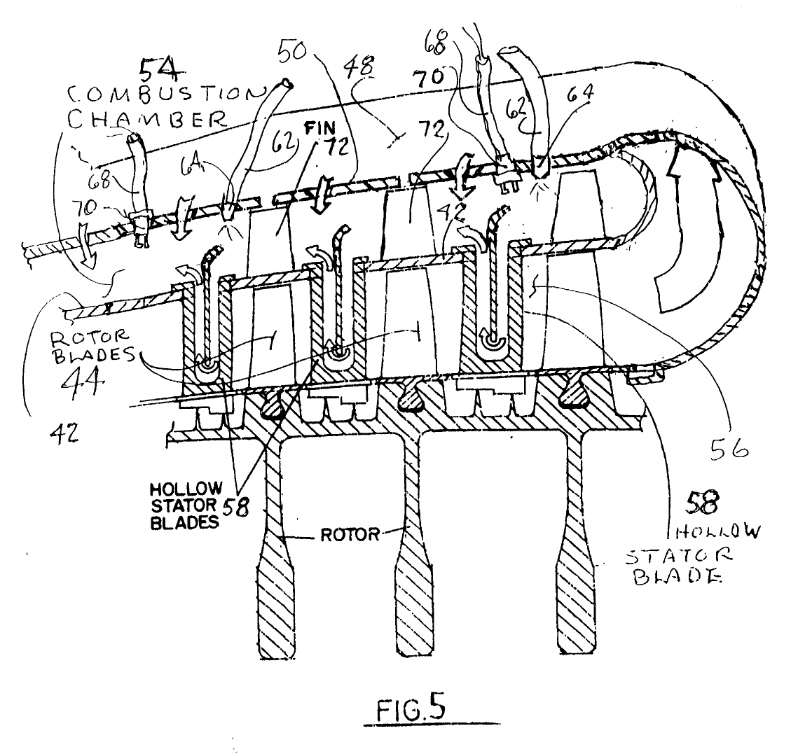

FIG. 5 shows a cross-sectional view of a portion of an integrated combustion chamber-hot air turbine unit 52 with details of isothermal combustion chamber 54 and with multiprocess expansion turbine 56 with hollow stator blades 58. Fuel supply system, not shown, supplies fuel to injector fuel lines 62 which provides fuel to injectors 64. Ignition system, not shown, energizes ignition wires 68 and ignitors 70. The upstream portion of combustion chamber heats the downstream portion of heated expander which is the isothermal portion and which requires a uniform temperature and uniform heat flux. Uniform fuel-air mixture and uniform temperature is assured by the multiple perforations in perforated combustion chamber wall 50 which distribute air throughout isothermal portion of combustion chamber of 54. Hallow stator blades 58 stimulate heat transfer from combustion gasses within isothermal combustion chamber 54 into expanding air within isothermally heated portion of multiprocess expansion turbine 56. In addition to transferring heat, fins 72, which are attached to turbine case 42, are so shaped and oriented to generate vortex and turbulent flow. Vortex flow is known to stimulate heat transfer and turbulence generators assure more uniform mixing and combustion as well as enhanced heat transfer. Uniform combustion chamber temperature and stimulated heat transfer support isothermal expansion as desired in the isothermal portion of the of the multiprocess expansion.

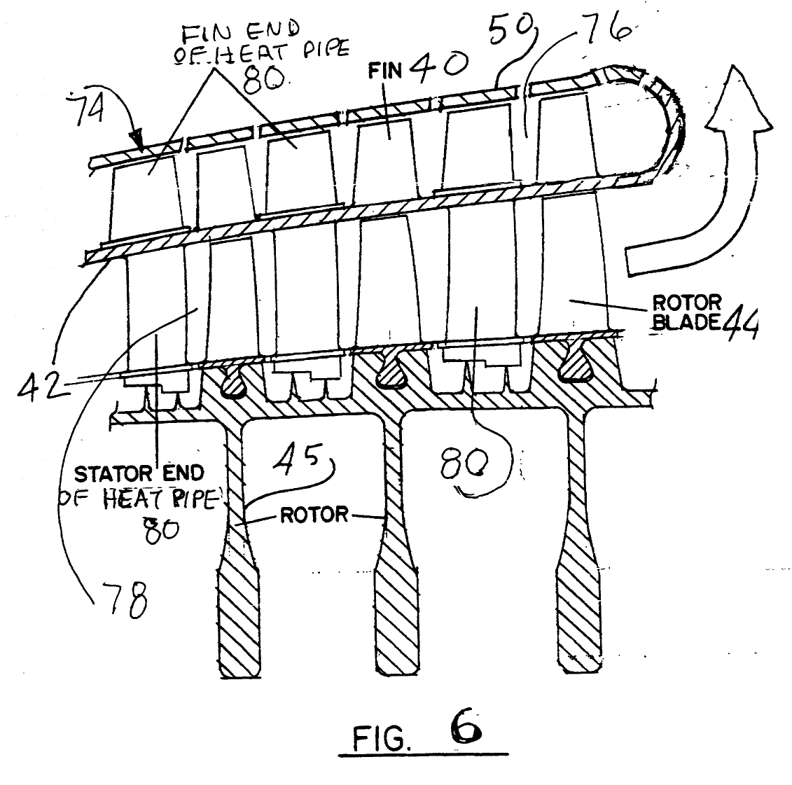

FIG. 6 shows portions of another embodiment of an integrated combustion chamber-hot air expansion turbine unit 74 with details of the combustion chamber 76 and with the multiprocess heated turbine 78 with heat-pipe stator-fins 80. The stator end of heat-pipe stator-fins 80 in multiprocess expansion turbine 78 functions both as a stator and as an additional heat transfer path into the expanding air within heated expansion turbine 78. In addition to transferring heat, fins 49 which are attached to turbine case 42, and the fin portion of heat pipe stator-fins 80 are so shaped and oriented to generate vortex and turbulent flow. Stimulated heat transfer through heat pipe stator-fins support heated multiprocess expansion as desired.

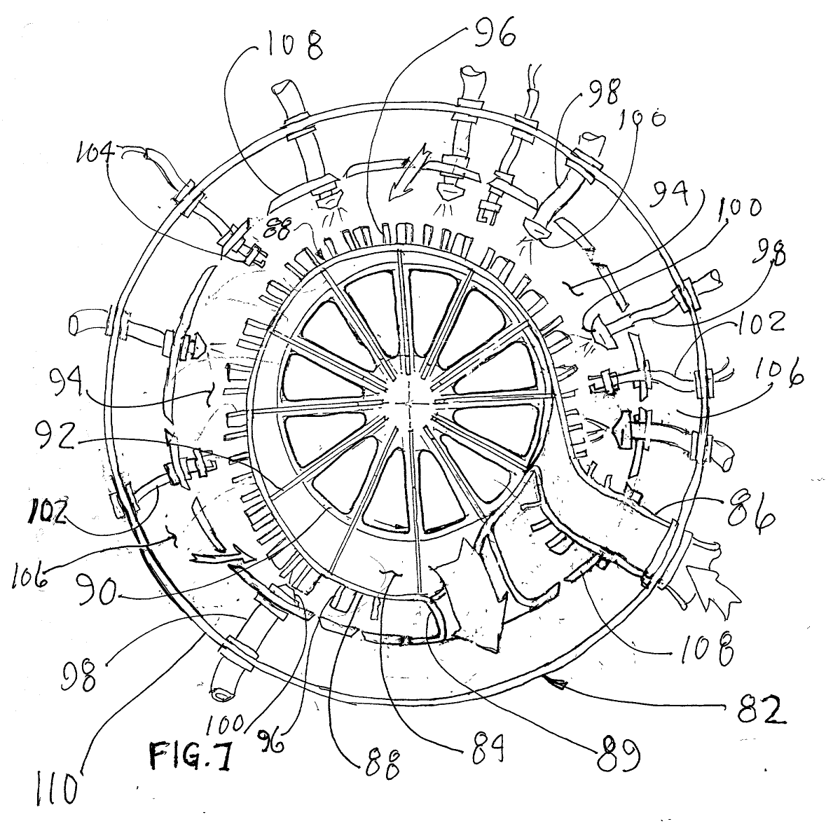

FIG. 7 shows a slide vane embodiment of a multiprocess external combustion 82 power system. Slide vane expansion engine 84 has an inlet 86, an expander case 88, a slotted rotor 90 and sliding vanes 92. Fins 96 are attached to exterior of expander case 88. Combustion chamber 94 is supplied fuel through fuel lines 98 and fuel injector 100 and ignition energy through ignition cables 102 and ignitors 104. Combustion chamber 84 is separated from air manifold 106 by a perforated combustion chamber wall 108. Air manifold 106 and entire multiprocess slide vane external combustion engine is enclosed within enclosure 110. Hot, pressurized air enters heated multiprocess slide vane external combustion engine through air inlet 86 and is endothermally expanded within heated multioprocess slide vane expander 84 prior to exhaust though expander outlet 89. Exhausted air flows into and around air manifold 106. Air is distributed through perforated combustion chamber wall 108 into combustion chamber 94. Air within combustion chamber 94 is mixed with fuel from fuel injectors 100. The fuel-air ratio within combustion chamber 94 is adjusted to generate the maximum temperature in the direct vicinity of the upstream portion of heated multiprocess slide vane expander. Maximum temperature in that portion of combustion chamber 94 is required to thermally support isobaric expansion there. Further downstream combustion temperature may be reduced to a level to thermally support heated isothermal expansion. The heated expanding air drives expander 84 to produce mechanical power. The combustion chamber outlet is out of plane of FIG. 7 and not shown.

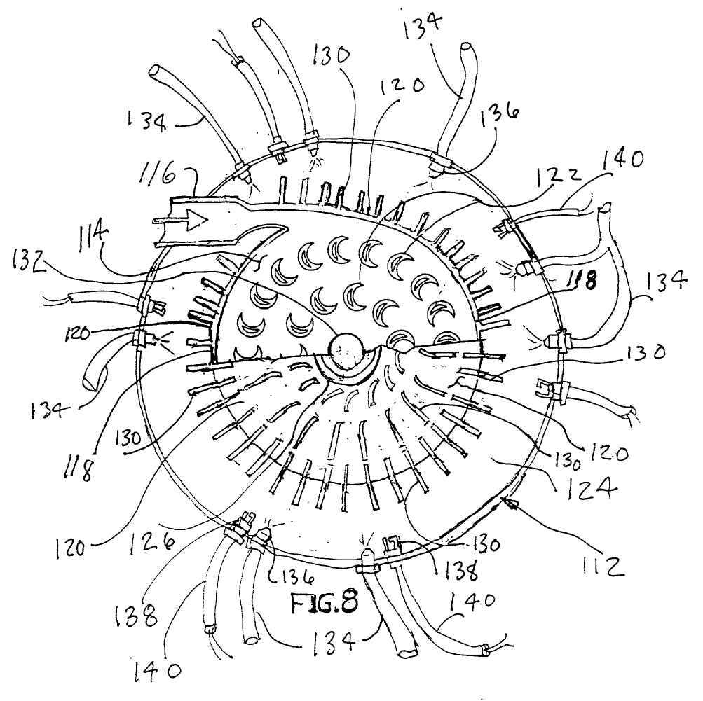

FIG. 8 shows a centripetal turbine embodiment of an external combustion multiprocess expansion engine 112. Heated multiprocess centripetal expander 114 has an inlet 116. An expansion chamber wall 118 and endplates 120 enclose centripetal expander 114. Stators 122, which direct expanding air into proper flow angle relative to rotors, not shown, may contain heat pipes for enhanced heat transfer between combustion chamber, 124 which surrounds centripetal expander 114 both radially and axially, and centripetal expander 114. A shaft shield 126 protects drive shaft, not shown, from combustion gases within combustion chamber 124. Fins 128 on expansion chamber wall 118 and endplates 120 are fitted with fins 130 to stimulate heat transfer into centripetal expander 114.

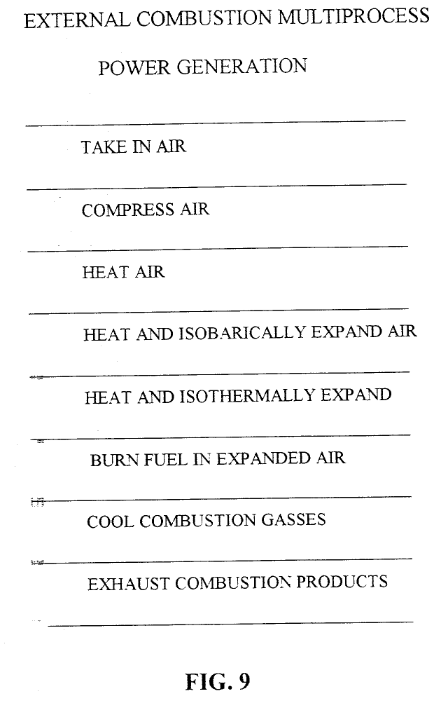

As a result of heated multiprocess expansion, the expanding air within centripetal expander 114 drives rotors to produce mechanical power. Hot, expanded air leaves centripetal expander 114 through central outlet 132 and flows into combustion chamber 124 which completely surrounds centripetal expander 114. Fuel which is supplied through fuel lines 134 and fuel injectors 136 mixes with hot, expanded air from centripetal expander 114 to form a combustible fuel air mixture. Ignitors 138 which are energized by means of ignition wires 140. The temperature within combustion chamber 124 is relatively higher in the region close to the periphery of centripetal expander 114 to assure that the expanding air at the inlet is heated sufficiently to generate a sufficient temperature rise to support isobaric expansion. In the downstream portion of centripetal expander 114 the combustion temperature is allowed to drop to the level where there is just sufficient heat flux for isothermal expansion. The process will smoothly progress from isobaric to isothermal expansion within the intermediate portion of centripetal expander 114. The constant, n in the polytropic process of an ideal gas, pVⁿ=constant, where p is the pressure and V is the volume of a closed system, will vary through centripetal expander 114 from approximately zero for isobaric expansion to approximately 1 for isothermal expansion. During the transition multiprocess expansion will be identified by a gentle and increasing rate of pressure drop with a slight and diminishing temperature rise until isothermal expansion is reached. FIG. 9 shows a simplified flow diagram of an external combustion multiprocess power generation process.

Although the above contains many specifications, these are directed to particular embodiments of the invention for the purpose of illustration and explanation. It will be apparent, however, to one skilled in the related art that many modifications and changes to the embodiments set forth above are possible without departing from the scope and the spirit of the invention. It is intended that the following claims be interpreted to embrace all such changes and modifications.

1. I claim an external combustion hot air engine comprising an air inlet, a compressor, a regenerative heat exchanger, a heated expander with multiprocess expansion, a combustion chamber, and an outlet duct and additional ducting means between said components as required, said components so arranged that:
said air inlet directs air into said compressor which is upstream of the cooler side of said regenerative heat exchanger which leads into said heated expander with multiprocess expansion which is immediately upstream, and surrounded by, said combustion chamber which comprises distributed air inlet means, fuel injector means and ignition means and which is immediately upstream of the hot side of said regenerative heat exchanger which exits into ambient through said outlet duct, said multiprocess hot air power system contains, in addition, a starter means, an ignition system, a fuel system, a control system, and structure as required, said components cooperate such that:
air entering said compressor is compressed and directed into cool side of said regenerative heat exchanger wherein it is heated by thermal contact with the flowing combustion products in the hot side of said regenerative heat exchanger after which heated air flows into said heated multiprocess expander wherein hot, heated expanding air generates mechanical energy prior to flowing into said combustion chamber, said combustion chamber comprising of hot air inlet means and fuel injector means which produce a combustible fuel air mixture as well as ignition means to ignite said combustible fuel air mixture, as desired, and from which air flows into the hot side of said downstream, regenerative heat exchanger from which air is exhausted through said exhaust ducting means, whereby compressed air is preheated prior to entrance into said heated multiprocess expander wherein compressed gas is heated sufficiently to thermally support isobaric or near isobaric expansion and wherein the expanded hot air is then heated further to support isothermal expansion and whereby hot air from said heated multiprocess expander efficiently supports combustion within said combustion chamber, and whereby said heated multiprocess expander operates more efficiently than an adiabatic expander and whereby said compressed air within said regenerative exchanger is heated by a higher temperature gas and whereby there are two paths for heat transfer into the working fluid, all of which result in a more efficient external combustion power cycle, as desired.

2. an external combustion hot air engine claimed in claim 1 with said combustion chamber being an isothermal combustion chamber with said heated multiprocess expander being immediately upstream, and surrounded by, said isothermal combustion chamber,
said isothermal combustion chamber comprises evenly distributed air inlet means, evenly distributed fuel injector means and evenly distributed ignition means, such that said isothermal combustion is maintained to efficiently provide the requisite heat to the immediately adjacent said heated multiprocess expander, as desired.

3. An external combustion hot air engine system as claimed in claim 1 wherein said heated multiprocess expander is in the form of a heated hot air axial turbine.

4. An external combustion hot air engine system as claimed in claim 1 wherein said heated multiprocess expander is in the form of a heated hot air centripetal turbine.

5. An external combustion hot air engine system as claimed in claim 1 wherein said heated multiprocess expander is in the form of a heated slide vane expansion motor.

6. An external combustion hot air engine as in claim 2 with said isothermal combustion chamber having in immediate vicinity, an air supply manifold and a multiply perforated combustion chamber wall between said air supply manifold and said isothermal combustion chamber such that air flow through said multiply perforated combustion chamber wall into said isothermal combustion chamber from said air supply manifold is evenly distributed to mix uniformly with fuel from said distributed fuel injector means within said isothermal combustion chamber such that an approximately uniform fuel air mixture is formed to support approximately isothermal combustion, as desired.

7. an external combustion hot air engine claimed in claim 1 with said combustion chamber having heat transfer augmentation means to augment the heat transfer from said combustion chamber into said adjacent expander, said heat transfer augmentation means selected from a group consisting of fins on surface of said combustion chamber surrounding said expander, swirl generating fins, hollow stators, structurally integrated fins and stators and structurally integrated fins and stators with internal heat pipes between them, such that heat transfer is sufficiently augmented to assure that the thermal requirements of isobaric and isothermal expansion are provided from said adjacent combustion chamber.

8. I claim an external combustion power generating process comprising intake and compression of ambient air, heating by heat transfer contact with hot combustion gasses, followed by power generating heated isobaric expansion, followed by power generating heated isothermal expansion, followed by combustion in previously expanded air and heat transfer of heat of combustion into expanding air, followed by cooling of combustion products in heat transfer contact with previously compressed air and exhaust of cooled combustion products into the ambient.
